(19) United States
(12) Patent Application Publication
(10) Pub. No.: US 2018/0366080 A1
(43) Pub. Date: Dec. 20, 2018

(54) Display Driver and Display Device

(71) Applicants: HKC Corporation Limited, Shenzhen City (CN); Chongqing HKC Optoelectronics Technology Co., ltd., Chongqing (CN)

(72) Inventor: YU-JEN CHEN, Chongqing (CN)

(21) Appl. No.: 15/869,539

(22) Filed: Jan. 12, 2018

Related U.S. Application Data
(63) Continuation of application No. PCT/CN2017/100476, filed on Sep. 5, 2017.

(30) Foreign Application Priority Data
Jun. 16, 2017 (CN) 201710458260.7

(51) Int. Cl. G09G 3/36; G09G 5/38; G09G 5/36; G02F 1/01; G02F 1/1345; G02F 1/1333

(52) U.S. Cl. CPC G09G 3/3648; G09G 5/38; G09G 5/363; G09G 3/3688; G02F 1/13452; G02F 1/133377; G02F 1/0105

(57) ABSTRACT

The circuit board includes a system control unit for receiving and processing a video input signal to obtain a low voltage differential signal, and a timing control unit for selecting, for example, a circuit board, used for receiving and processing said low voltage differential signal to obtain a multi-point low voltage differential signal; a digital to analog conversion unit, used for receiving the multi-point low voltage differential signal and converting the multi-point low voltage differential signal into a corresponding digital signal; and a transmission unit for transmitting the digital signal to the display panel. The present application also discloses a display device.

### TECHNICAL FIELD

The present application relates to the field of display technology, and more particularly to a display panel detection method, apparatus and system.

### BACKGROUND OF RELATED ART

With the development of liquid crystal display, liquid crystal display device toward the light, low power consumption, low cost direction, especially in low cost. In general, the display device comprises a display drive architecture, and the display drive architecture typically comprises the image data processing chip and the transmission interfaces for the various image data, but the transmission and the reception interfaces of the image data take up a lot of the corresponding chip resource. It not only causes an increase in the production cost of the entire display device, but also causes the processing speed of the image data to be slowed down.

### SUMMARY

The present application provides a display driver and a display device. The present application simplifies the structure, improves the processing speed of the image data, and reduces the production cost.

In one aspect, the present application provides a display driver, the display driver including: a circuit board.

The circuit board comprises the following elements: a system control unit, used for receiving and processing the video input signal to obtain a low voltage differential signal; a timing control unit, used for receiving and processing the low voltage differential signal to obtain a multi-point low voltage differential signal; a digital-to-analog conversion unit, used for receiving the multi-point low voltage differential signal and converting the multi-point low voltage differential signal into a corresponding digital signal; and a transmission unit, used for transmitting the digital signal to the display panel.

In another aspect, the present application provides a display driver including: a circuit board.

The circuit board comprises the following elements: a system control unit, used for receiving and processing the video input signal to obtain a low voltage differential signal; a timing control unit, used for receiving and processing the low voltage differential signal to obtain a multi-point low voltage differential signal; a digital-to-analog conversion unit, used for receiving the multi-point low voltage differential signal and converting the multi-point low voltage differential signal into a corresponding digital signal; and a transmission unit, used for transmitting the digital signal to the display panel; a third dark/bright compensation unit, used for receiving the multi-point low voltage differential signal and performing dark/bright compensation to obtain a third compensation signal; a third backlight adjustment unit, used for receiving the third compensation signal and adjusting the backlight data to obtain a third adjustment signal; a third motion picture quality compensation unit, used for receiving the third adjustment signal and transmitting a third adjustment signal after performing motion picture quality compensation to the digital to analog conversion unit.

The system control unit comprises: a first processing unit, used for receiving a video input signal and performing a corresponding data conversion to obtain a first processing signal; a first dark/bright compensation unit, used for receiving the first processing signal and performing dark/bright compensation to obtain a first compensation signal; a first backlight adjustment unit, used for receiving the first compensation signal and adjusting the backlight data to obtain a first adjustment signal; a first motion picture quality compensation unit, used for receiving the first adjustment signal and performing motion quality compensation to obtain a low voltage differential signal.

In yet another aspect, the present application provides a display device including a display panel and a display driver for driving the display panel, the display driver including: a circuit board.

The circuit board comprises the following elements: a system control unit for receiving and processing the video input signal to obtain a low voltage differential signal; a timing control unit for receiving and processing the low voltage differential signal to obtain a multi-point low voltage differential signal; a digital-to-analog conversion unit for receiving the multi-point low voltage differential signal and converting the multi-point low voltage differential signal into a corresponding digital signal; and a transmission unit for transmitting the digital signal to the display panel.

The embodiment of the present application can simplify the structure, improve the processing speed of the image data, reduce the production cost, and reduce the power consumption during the display driver's use, and the structure of the display device to which the display driver is applied is made thinner. The various units of the present application are provided on the same circuit board, so that the structure of the display driver is more concise and the present application also reduces the design of the transmission interface and the decoding interface between the respective units. Hence, each data signal can be transmitted in one of the cells processing conversion and then to the next unit so as to save the data signal transmission time and to simplify the composition of the various units structure, user-friendly production and use.

### BRIEF DESCRIPTION OF THE DRAWINGS

In order to provide a clearer description of the embodiments of the present application, the accompanying drawings, which are intended to be used in the description of the embodiments, will be briefly described. It will be apparent that the following description is a part of the present application. In the ordinary skill of the present invention, other drawings may be obtained in accordance with these drawings without paying creative work.

FIG. 1 is a schematic flow diagram of a display driver provided in an embodiment of the present application.

FIG. 2 is a schematic diagram of a sub-structure of a system control unit 102 in a display driver provided in the embodiment of the present application.

FIG. 3 is a schematic diagram of a sub-structure of a timing control unit 103 in a display driver provided in the embodiment of the present application.

FIG. 4 is a schematic view of a display driver provided in another embodiment of the present application.

FIG. 5 is a schematic structural view of a display device provided by the application embodiment.

### DETAILED DESCRIPTION OF EMBODIMENTS

The Below in conjunction with the present invention in the accompanying drawings, technical solutions of embodiments of the present invention are clearly and completely described, obviously, the described embodiments are part of the embodiments of the present invention rather than all embodiments. Based on the embodiments of the present invention, all other embodiments of ordinary skill in the art without any creative effort shall fall within the scope of the present invention.

It should be appreciated that, when used in this specification and the appended claims, the terms “comprise” and “comprising” indicates that the described features, integers, steps, operations, elements and/or components, but do not exclude one or more other features, integers, steps, operations, elements, components and/or the presence or addition of collection.

It should also be understood that the terminology used in the present description of the invention only and are not intended to limit the present invention for the purpose of describing particular embodiments. As used in the specification and the appended claims of the invention as used in the book, unless the context clearly dictates otherwise, the singular forms “a”, “an” and “the” are intended to include the plural forms. It will be further understood that the present description the specification and the appended claims the term “and/or” means that one item associated listed combinations of any and all possible combinations or in a plurality, and these include combinations.

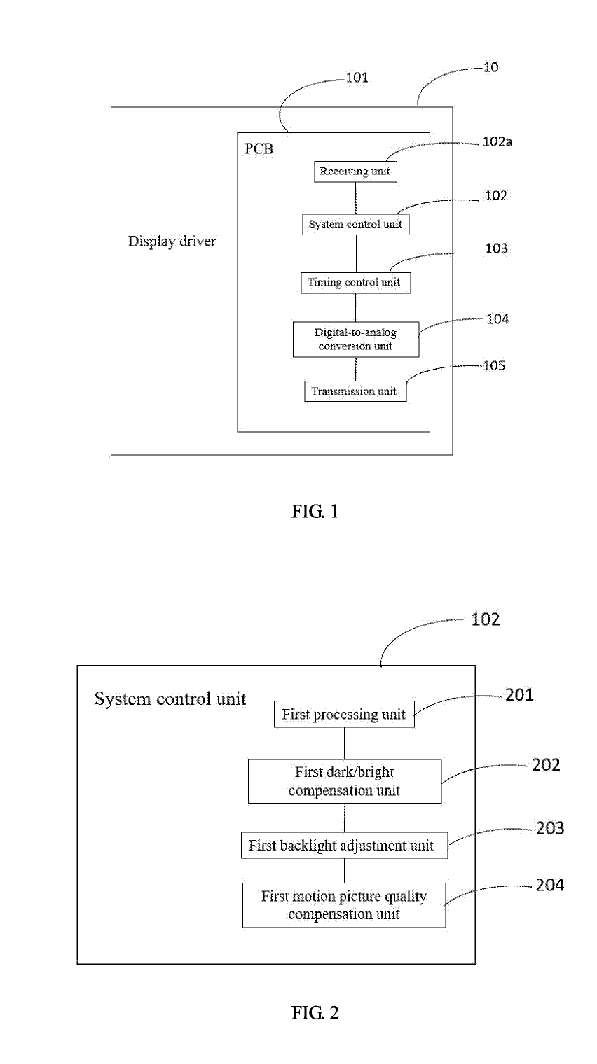

Referring to FIG. 1. FIG. 1 is an embodiment of the present application provided a schematic structural diagram of a display driver. As show in FIG. 1, the display driver 10 may comprises a circuit board 101; the circuit board 101 may comprise the following units: system control unit 102, timing control unit 103, a digital to analog conversion unit 104 and a transmission unit 105.

The system control unit 102 is configured to receive and process the video input signal to obtain a low voltage differential signal.

The video input signal may be any one of an HDMI signal, a DVI signal, and a USB signal. The system control unit 102 can convert the video input signal accordingly, and the corresponding optimization can be performed according to the actual situation.

Alternatively, please see FIG. 2. The embodiment of the present application provides a sub-structure schematic view of the system control unit 102 of a display. The system control unit 102 may specifically comprise a first processing unit 201, a first dark/bright compensation unit 202, a first backlight adjustment unit 203, and a first motion picture quality compensation unit 204.

The first processing unit 201 is configured to receive a video input signal and perform a corresponding data conversion to obtain a first processing signal. The first processing unit 201 directly converts the video input signal into a corresponding data after receiving the video input signal so as to be processed by the subsequent unit.

The first dark/bright compensation unit 202 is adapted to receive the first processed signal and perform dark/bright compensation to obtain a first compensation signal. The first dark/bright compensation unit 202 is capable of performing corresponding data compensation on the first processed signal so as to achieve a deblocking process such that the resulting first compensation signal has a better display effect.

The first backlight adjustment unit 203 is configured to receive the first compensation signal and adjust the backlight data to obtain a first adjustment signal. The first backlight adjustment unit 203 is capable of performing a corresponding data compensation adjustment on the first compensation signal so as to realize adjustment of the backlight luminance so that the resulting first adjustment signal has a better display effect.

The first motion picture quality compensation unit 204 is configured to receive the first adjustment signal and perform motion quality compensation to obtain a low voltage differential signal. The first motion picture quality compensation unit 204 is capable of performing a corresponding data compensation adjustment for the first adjustment signal so as to realize a certain motion quality compensation, and the low voltage differential signal obtained at this time has been had the various aspects of optimized process with better display.

The timing control unit 103 is configured to receive and process the low voltage differential signal to obtain a multi-point low voltage differential signal.

The low voltage differential signal is converted by a timing control unit 103 to obtain a multi-point low voltage differential signal with an enhanced viewing angle, and the multi-point low voltage differential signal is a signal with a high transmission rate. Hence, the high definition image can be quickly transmitted to display. It spends less time for signal transmission. The user's experience is enhanced better. At the same time, in order to better display, the multi-point low voltage differential signal is further optimized according to the actual situation.

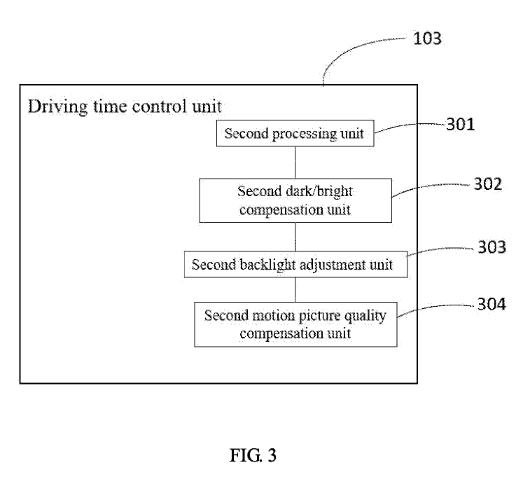

Alternatively, please see FIG. 3. In fact, the application of the present embodiment provides a sub-structure diagram of the drive timing control unit 103. The timing control unit 103 may comprises a second processing unit 301, a second dark/bright adjustment unit 302, a second backlight adjustment unit 303, and a second motion picture quality compensation unit 304 respectively.

The second processing unit 301 is configured to receive a low voltage differential signal and perform a corresponding data conversion to obtain a second processing signal. The second processing unit 301 directly converts the low-voltage differential signal into a corresponding data after receiving the low-voltage differential signal to be a second processing signal so that the subsequent unit performs processing.

The second dark/bright compensation unit 302 is adapted to receive the second processing signal and perform dark/bright compensation to obtain a second compensation signal. The second dark/bright compensation unit 302 is capable of performing corresponding data compensation on the second processed signal so as to achieve a deblocking process such that the resulting second compensation signal has a better display effect.

The second backlight adjustment unit 303 is configured to receive the second compensation signal and adjust the backlight data to obtain a second adjustment signal. The second backlight adjustment unit 303 is capable of performing a corresponding data compensation adjustment on the second compensation signal so as to realize adjustment of the backlight luminance so that the resulting second adjustment signal has a better display effect.

The second motion picture quality compensation unit 304 is configured to receive the second adjustment signal and perform motion quality compensation to obtain a multi-point low voltage differential signal. The second motion picture quality compensation unit 304 is capable of performing a corresponding data compensation adjustment on the second adjustment signal so as to realize a certain motion quality compensation, and the resulting multi-point low voltage differential signal has been had various aspects of optimization processing with better display effect.

The digital-to-analog conversion unit 104 is configured to receive the multipoint low voltage differential signal and convert the multipoint low voltage differential signal into a corresponding digital signal.

After the digital-to-analog conversion unit 104 receives the multi-point low-voltage differential signal, it is necessary to perform digital-to-analog conversion of the multi-point low voltage differential signal to obtain a corresponding digital signal.

The transmission unit 105 is configured to transmit the digital signal to a display panel. The transmission unit 105 is an interface between the display controller and the display panel or other display device so as to transmit the digital signal to the display panel, or other display device for display.

Alternatively, the display controller may further comprise a receiving unit 102a. The receiving unit 102a is disposed on the circuit board 101 to obtain the video signal. And then the video signal is transmit to the system control unit 102.

In general, the system control unit 102, the timing control unit 103, the digital-to-analog conversion unit 104, and the transmission unit 105 are integrated on a circuit board. It not only saves the space occupied by each unit, but also omits the design of interface between transmission and decoding interface of each units. The present application makes the entire display controller structure is more simple, reduces the relevant production process. It can not only reduce production costs and improve production efficiency, but also can make the data transmission faster.

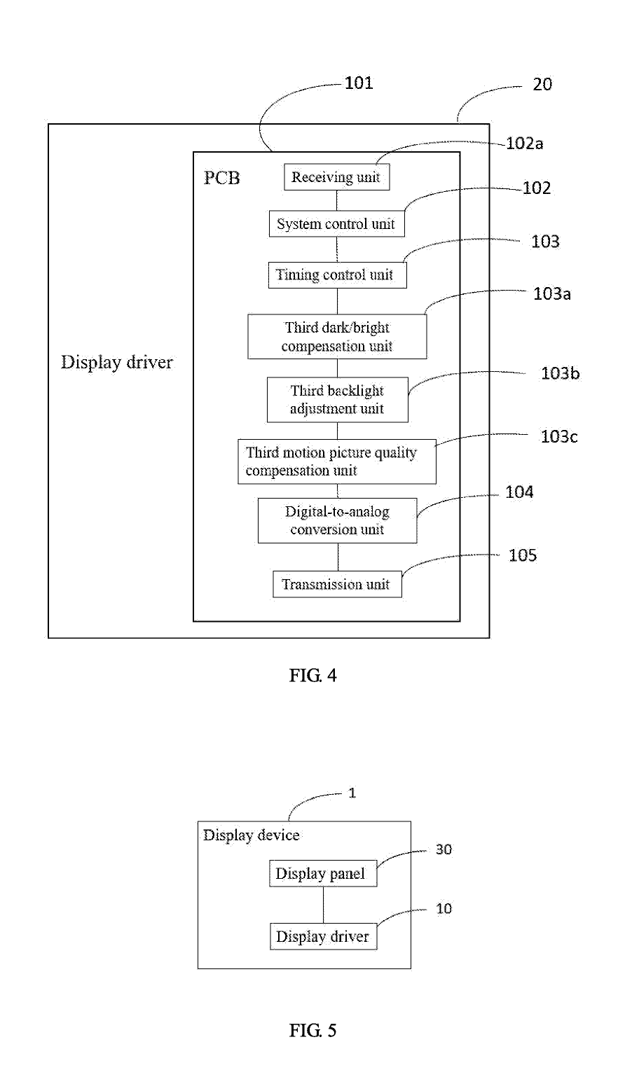

Refer to FIG. 4. It is a schematic structural view of a display driver provided in another embodiment of the present application. The display driver 20 shown in the figure differs from the above-described embodiment of the present application as follows:

When the system control unit 102 receives the video input signal and performs a corresponding data conversion to obtain a low voltage differential signal, and the timing control unit 103 receives the low voltage differential signal and performs a corresponding data conversion to obtain a multi-point low voltage differential signal. In order to further optimize the multi-point low voltage differential signal, the display driver may comprise a third dark/light compensation unit 103a, a third backlight adjustment unit 103b, and a third motion picture quality compensation unit 103c.

The third dark/bright compensation unit 103a is configured to receive the multi-point low voltage differential signal and perform dark/bright compensation to obtain a third compensation signal. The third dark/bright compensation unit 103a is capable of performing corresponding data compensation on the multi-point low voltage differential signal so as to achieve a deblocking process such that the resulting third compensation signal has a better display effect.

The third backlight adjustment unit 103b is configured to receive the third compensation signal and adjust the backlight data to obtain a third adjustment signal. The third backlight adjustment unit 103b is capable of performing a corresponding data compensation adjustment on the third compensation signal so as to realize adjustment of the backlight luminance so that the resulting third adjustment signal has a better display effect.

The third adjustment signal quality of the third motion compensation unit 103c receives the third adjustment signal, and the motion compensated picture is sent to the digital to analog conversion unit 104. The third motion picture quality compensation unit 103c is capable of performing a corresponding data compensation adjustment on the third adjustment signal so as to realize a certain motion quality compensation. The third adjustment signal is obtained after the motion picture quality compensation has been compensated in a multi-faceted optimization of the multi-point low-voltage differential signal. It has a better display.

In general, the use of the display driver in the present application not only simplifies the product structure, improves the processing speed of the image data, but also reduces the production cost while the power consumption is reduced during the display driver usage. The present application makes the more light structure of the drive's product.

Refer to FIG. 5. A schematic structural drawing of a display device is provided by the embodiment of the present application. The display device 1 comprises a display panel 30 and a display driver 10. The display driver 10 is used for driving the display panel 30. The display device further comprises an input device. It may comprise a fingerprint pick sensor (for collecting the fingerprint information of the user and the direction information of the fingerprint), a microphone. At the same time, the display device may be provided with components such as a speaker.

The display panel 30 may be a liquid crystal display panel, an OLED display panel, a QLED display panel, a surface display panel, or other display panel.

The display driver 10 may be a display driver as described above. Specifically, referring to FIG. 1, the display driver 10 may include a circuit board 101. The system is provided on the circuit board 101 of the control unit 102, a timing control unit 103, a digital to analog conversion unit 104 and a transmission unit 105. As a further optional, the display controller may also include a receiving unit 102a.

Alternatively, see FIG. 2. The system control unit 102 may specifically comprises a first processing unit 201, a first dark/bright pattern compensation unit 202, a first backlight adjustment unit 203, and a first motion picture quality compensation unit 204.

Alternatively, see FIG. 3. The timing control unit 103 may comprise a first processing unit 201, a first dark/bright pattern compensation unit 202, a first backlight adjustment unit 203, and a first motion compensation unit 204 image quality.

Refer to FIG. 4. In other embodiments of the present application, when the system control unit 102 receives a video input signal and converts the corresponding data to obtain a low voltage differential signal. The timing control unit 103 receives the low voltage differential signal and converts the data to obtain a multi-point low voltage differential signal correspondingly. In order to further optimize the multi-point low voltage differential signal, the display driver may also comprise a third dark/bright compensation unit 103a, a third backlight adjustment unit 103b, and third motion picture quality compensation unit 103c.

The functions of the respective units in the display driver 10 and their mating relationships and working principle are described in detail in the above-described embodiment. It will not be described again.

In general, the use of the display driver in the present application not only simplifies the product structure, improves the processing speed of the image data, but also reduces the production cost while the power consumption is reduced during the display driver usage. The structure of the drive's product is lighter.

The units in the terminal of the embodiments of the present application may be combined, divided and deleted according to actual needs.

The units described as the separation means may or may not be physically separate, and the components of display units may or may not be physical units, i.e., may be located in one place or may be distributed over a plurality of network elements. The part or all of the units may be selected according to the actual needs to achieve the purpose of the embodiment of the present application.

In addition, the functional units in the various embodiments of the present application may be integrated in one processing unit, or each unit may be physically present, or two or more units may be integrated in one unit. The above-mentioned integrated unit can be implemented either in the form of hardware or in the form of software functional units.

The above are only preferred specific embodiment of the present application embodiment, but the scope of the present application is not limited thereto, any skilled in the art in the art within the technical scope disclosed in the present application can be easily thought variations or replacements shall fall within the scope of the present application. Accordingly, the scope of the present disclosure should be defined by the scope of the claims.

What is claimed is:

1. A display driver comprising:
a circuit board;
wherein the circuit board comprises:
a system control unit, used for receiving and processing a video input signal to obtain a low voltage differential signal;
a timing control unit, used for receiving and processing the low voltage differential signal to obtain a multi-point low voltage differential signal;
a digital-to-analog conversion unit, used for receiving the multi-point low voltage differential signal and converting the multi-point low voltage differential signal into a corresponding digital signal; and
a transmission unit, used for transmitting the digital signal to a display panel.

2. The display driver according to claim 1, further comprising:
a receiving unit provided on the circuit board to obtain a video input signal and transmit the video input signal to the system control unit.

3. The display driver according to claim 1, wherein the system control unit comprises:
a first processing unit, used for receiving a video input signal and performing a corresponding data conversion to obtain a first processing signal;
a first dark/bright compensation unit, used for receiving the first processing signal and performing dark/bright compensation to obtain a first compensation signal;
a first backlight adjustment unit, used for receiving the first compensation signal and adjusting a backlight data to obtain a first adjustment signal;
a first motion picture quality compensation unit, used for receiving the first adjustment signal and performing motion quality compensation to acquire a low voltage differential signal.

4. The display driver according to claim 2, wherein the system control unit comprises:
a first processing unit, used for receiving a video input signal and performing a corresponding data conversion to obtain a first processing signal;
a first dark/bright compensation unit, used for receiving the first processing signal and performing dark/bright compensation to obtain a first compensation signal;
a first backlight adjustment unit, used for receiving the first compensation signal and adjusting a backlight data to obtain a first adjustment signal;
a first motion picture quality compensation unit, used for receiving the first adjustment signal and performing motion quality compensation to obtain a low voltage differential signal.

5. The display driver according to claim 1, wherein the timing control unit comprises:
a second processing unit, used for receiving a low voltage differential signal and performing a corresponding data conversion to obtain a second processing signal;
a second dark/bright compensation unit, used for receiving the second processing signal and performing dark/bright compensation to obtain a second compensation signal;
a second backlight adjustment unit, used for receiving the second compensation signal and adjusting the backlight data to obtain a second adjustment signal; and
a second motion picture quality compensation unit, used for receiving the second adjustment signal and performing motion picture quality compensation to obtain a multi-point low voltage differential signal.

6. The display driver according to claim 2, wherein the timing control unit comprises:
a second processing unit, used for receiving a low voltage differential signal and performing a corresponding data conversion to obtain a second processing signal;
a second dark/bright compensation unit, used for receiving the second processing signal and performing dark/bright compensation to obtain a second compensation signal;
a second backlight adjustment unit, used for receiving the second compensation signal and adjusting the backlight data to obtain a second adjustment signal;
a second motion picture quality compensation unit, used for receiving the second adjustment signal and performing motion picture quality compensation to obtain a multi-point low voltage differential signal.

7. The display driver according to claim 3, wherein said timing control unit comprises:
a second processing unit, used for receiving a low voltage differential signal and performing a corresponding data conversion to obtain a second processing signal;
a second dark/bright compensation unit, used for receiving the second processing signal and performing dark/bright compensation to obtain a second compensation signal;
a second backlight adjustment unit, used for receiving the second compensation signal and adjusting the backlight data to obtain a second adjustment signal;
a second motion picture quality compensation unit, used for receiving the second adjustment signal and performing motion picture quality compensation to acquire a multi-point low voltage differential signal.

8. The display driver according to claim 4, wherein the timing control unit comprises:
a second processing unit, used for receiving a low voltage differential signal and performing a corresponding data conversion to acquire a second processing signal;
a second dark/bright compensation unit, used for receiving the second processing signal and performing dark/bright compensation to obtain a second compensation signal;
a second backlight adjustment unit, used for receiving the second compensation signal and adjusting the backlight data to obtain a second adjustment signal;
a second motion picture quality compensation unit, used for receiving the second adjustment signal and performing motion picture quality compensation to obtain a multi-point low voltage differential signal.

9. The display driver according to claim 1, further comprising:
a third dark/bright compensation unit, used for receiving the multi-point low voltage differential signal and performing dark/bright compensation to obtain a third compensation signal;
a third backlight adjustment unit, used for receiving the third compensation signal and adjusting a backlight data to obtain a third adjustment signal;
a third motion picture quality compensation unit, used for receiving the third adjustment signal and transmitting the third adjustment signal after performing motion picture quality compensation to the digital to analog conversion unit.

10. The display driver according to claim 2, further comprising:
a third dark/bright compensation unit, used for receiving the multi-point low voltage differential signal and performing dark/bright compensation to obtain a third compensation signal;
a third backlight adjustment unit, used for receiving the third compensation signal and adjusting a backlight data to obtain a third adjustment signal;
a third motion picture quality compensation unit, used for receiving the third adjustment signal and transmitting the third adjustment signal after performing motion picture quality compensation to the digital to analog conversion unit.

11. A display driver comprising,
a circuit board;
wherein the circuit board comprises:
a system control unit, used for receiving and processing a video input signal to obtain a low voltage differential signal;
a timing control unit, used for receiving and processing the low voltage differential signal to obtain a multi-point low voltage differential signal;
a digital-to-analog conversion unit, used for receiving the multi-point low voltage differential signal and converting the multi-point low voltage differential signal into a corresponding digital signal; and
a transmission unit, used for transmitting the digital signal to the display panel;
a third dark/bright compensation unit, used for receiving the multi-point low voltage differential signal and performing dark/bright compensation to obtain a third compensation signal;
a third backlight adjustment unit, used for receiving the third compensation signal and adjusting a backlight data to obtain a third adjustment signal;
a third motion picture quality compensation unit, used for receiving the third adjustment signal and transmitting a third adjustment signal for performing motion picture quality compensation to the digital to analog conversion unit;
wherein the system control unit comprises:
a first processing unit, used for receiving a video input signal and performing a corresponding data conversion to obtain a first processing signal;
a first dark/bright compensation unit, used for receiving the first processing signal and performing dark/bright compensation to obtain a first compensation signal;
a first backlight adjustment unit, used for receiving the first compensation signal and adjusting the backlight data to obtain a first adjustment signal;
a first motion picture quality compensation unit, used for receiving the first adjustment signal and performing motion quality compensation to acquire a low voltage differential signal.

12. A display device comprising:
a display panel;
a display driver, used for driving the display panel, the display driver comprising:
a circuit board;
wherein the circuit board comprises:
a system control unit, used for receiving and processing the video input signal to obtain a low voltage differential signal;
a timing control unit, used for receiving and processing the low voltage differential signal to obtain a multi-point low voltage differential signal;
a digital-to-analog conversion unit used for receiving the multi-point low voltage differential signal and converting the multi-point low voltage differential signal into a corresponding digital signal; and
a transmission unit, used for transmitting the digital signal to the display panel.

13. The display device according to claim 12, wherein the display driver further comprises:
a receiving unit provided on the circuit board to acquire a video input signal and transmit the video input signal to the system control unit.

14. The display device according to claim 12, wherein the system control unit comprises:
a first processing unit, used for receiving a video input signal and performing a corresponding data conversion to obtain a first processing signal;
a first dark/bright compensation unit, used for receiving the first processing signal and performing dark/bright compensation to obtain a first compensation signal;
a first backlight adjustment unit, used for receiving the first compensation signal and adjusting the backlight data to obtain a first adjustment signal;
a first motion picture quality compensation unit, used for receiving the first adjustment signal and performing motion quality compensation to obtain a low voltage differential signal.

15. The display device according to claim 13, wherein the system control unit comprises:
a first processing unit, used for receiving a video input signal and performing a corresponding data conversion to obtain a first processing signal;
a first backlight adjustment unit, used for receiving the first compensation signal and adjusting the backlight data to obtain a first adjustment signal;
a first backlight adjustment unit, used for receiving the first compensation signal and adjusting the backlight data to obtain a first adjustment signal;
a first motion picture quality compensation unit, used for receiving the first adjustment signal and performing motion quality compensation to obtain a low voltage differential signal.

16. The display device according to claim 12, wherein the timing control unit comprises:
a second processing unit, used for receiving a low voltage differential signal and performing a corresponding data conversion to obtain a second processing signal;
a second dark/bright compensation unit, used for receiving the second processing signal and performing dark/bright compensation to obtain a second compensation signal;
a second backlight adjustment unit, used for receiving the second compensation signal and adjusting the backlight data to obtain a second adjustment signal;
a second motion picture quality compensation unit, used for receiving the second adjustment signal and performing motion picture quality compensation to obtain a multi-point low voltage differential signal.

17. The display device according to claim 13, wherein the timing control unit comprises:
a second processing unit, used for receiving a low voltage differential signal and performing a corresponding data conversion to obtain a second processing signal;
a second dark/bright compensation unit, used for receiving the second processing signal and performing dark/bright compensation to obtain a second compensation signal;
a second backlight adjustment unit, used for receiving the second compensation signal and adjusting the backlight data to obtain a second adjustment signal;
a second motion picture quality compensation unit, used for receiving the second adjustment signal and performing motion picture quality compensation to obtain a multi-point low voltage differential signal.

18. The display device according to claim 14, wherein said timing control unit comprises:
a second processing unit, used for receiving a low voltage differential signal and performing a corresponding data conversion to obtain a second processing signal;
a second dark/bright compensation unit, used for receiving the second processing signal and performing dark/bright compensation to obtain a second compensation signal;
a second backlight adjustment unit, used for receiving the second compensation signal and adjusting the backlight data to obtain a second adjustment signal;
a second motion picture quality compensation unit, used for receiving the second adjustment signal and performing motion picture quality compensation to obtain a multi-point low voltage differential signal.

19. The display device according to claim 15, wherein the timing control unit comprises:
a second processing unit, used for receiving a low voltage differential signal and performing a corresponding data conversion to obtain a second processing signal;
a second dark/bright compensation unit, used for receiving the second processing signal and performing dark/bright compensation to obtain a second compensation signal;
a second backlight adjustment unit, used for receiving the second compensation signal and adjusting the backlight data to obtain a second adjustment signal;
a second motion picture quality compensation unit, used for receiving the second adjustment signal and performing motion picture quality compensation to obtain a multi-point low voltage differential signal.

20. The display device according to claim 12, wherein the display driver further comprises:
a third dark/bright compensation unit, used for receiving the multi-point low voltage differential signal and performing dark/bright compensation to obtain a third compensation signal;
a third backlight adjustment unit, used for receiving the third compensation signal and adjusting the backlight data to obtain a third adjustment signal;
a third motion picture quality compensation unit, used for receiving the third adjustment signal and transmitting the third adjustment signal after performing motion picture quality compensation to the digital to analog conversion unit.
